(19) United States
(12) Patent Application Publication
(10) Pub. No.: US 2003/0011790 A1
(43) Pub. Date: Jan. 16, 2003

(54) Correcting exposure and tone scale of digital images using a plurality of transforms

(75) Inventors: Carl P. Schulte, Penfield, NY (US); Paul B. Gilman, Penfield, NY (US); Robert P. Collette, Pavilion, NY (US); Harry D. Franchino, Fairport, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/899,326

(22) Filed: Jul. 5, 2001

(51) Int. Cl. G06F 15/00; B41J 1/00

(52) U.S. Cl. 358/1.1

(57) ABSTRACT

A method for correcting for exposure in a digital image which was captured by an image capture device and which is to be printed on a printer which forms monochrome or color images, on a medium, including providing a plurality of exposure and tone scale correcting transforms, each such transform being unique to an exposure condition and which corrects exposure and tone scale for a digital image captured by the capture device for such unique exposure conditions and to be printed by the printer, applying the plurality of transforms to the digital image and printing a plurality of images corresponding to the digital image on which the transforms were applied, and determining the most satisfying printed image to the user which corresponds a particular transform to be used to make visual images from the digital image.

### CROSS REFERENCE TO RELATED APPLICATIONS

Reference is made to commonly assigned U.S. patent application Ser. No. 09/215,733 filed Dec. 18, 1998 entitled “Correcting Exposure and Tone Scale of Digital Images Captured by an Image Capture Device” by Paul B. Gilman et al.; the disclosure of which is incorporated herein by reference.

### FIELD OF THE INVENTION

This invention relates to a method of providing improved prints (images on media) by a printer from images captured by a capture device over a wide variety of exposure conditions.

### BACKGROUND OF THE INVENTION

One of the most difficult problems in the making of digital prints from the digital image files produced by digital cameras, is the correction for exposure errors made by the camera at the time of image capture. For the optical printing of negative film images the solution for under and over exposure is simply a linear change in the duration of light exposure at the time of printing because the negative film is a simple record of density as a function of exposure for any scene.

It is important in producing displays or prints from digital images to fit the dynamic range of the originally captured scene to the dynamic range of the materials available for displaying or printing using the best possible transform. A limiting factor is the dynamic range of the materials available for displaying or printing. By selectively choosing the proper transform for displaying or printing, it is possible to display or print aesthetically pleasing images on materials that have less dynamic range than the original scene.

As new materials such as thermal print media and ink jet technologies have become available for printing, they have introduced a larger dynamic range than available with previous technologies. It is well known how to print digital images on these types of media. However, it is difficult to design different transforms that best take advantage of these new media. A key element in any new transform is to be able to utilize the full dynamic range of the media for displaying or printing the digital images.

There have been a number of techniques for improving the tone scale of digital images, see for example, U.S. Pat. No. 4,792,518 and U.S. Pat. No. 5,300,381. For a discussion of tone scale, see “The Tone Reproduction of Colour Photographic Materials,” R. W. G. Hunt, I. T. Pitt, and P. C. Ward, J. Photog. Sci., 17:198(1969).

As set forth in the above disclosures, the techniques for making the images are very complex and require that the media be photographic media. The publication by Hunt et al. describes the “ideal system” for printing photographic images to correct for camera flare, printer flare, and viewing flare but offers no practical way to implement this theoretical tone reproduction curve because of the lack of digital imaging tools and the limitations of the materials available in 1969.

U.S. Pat. No. 5,528,339 discloses techniques for improving the tone reproduction of digital images on other media such as thermal, ink jet and electrophotographic. However, the media now available for the printing of the digital images far exceeds the dynamic range previously described by having lower minimum densities and considerably higher maximum densities.

Heretofore, in digital image processing, each image is processed separately. By that is meant the digital image file is individually tone scaled for that one image. This, of course, is a time consuming process and is a major drawback in the use of digital images captured by a typical consumer. This is especially true when it is realized that a typical amateur photographer (using film or digital cameras) captures images over a wide variety of photographic situations and under different exposure conditions which result in images which may be either under or over exposed compared to a normal exposure.

Digital images are often stored in a “rendered” image space, such as SRGB a screen display RGB (red, green, blue) color space, where the relationship between the image code values and the scene luminance values is very non-linear. These SRGB images may contain exposure and tone scale errors, where the key objects are lighter or darker than desired by the user, due to imperfect exposure determination algorithms in the digital camera or film scanner, which created the digital image.

Many imaging applications, such as Adobe Photoshop or Kodak Picture Easy, allow the user to adjust the “brightness”, “contrast”, and/or “gamma” of the image by sliding using one or more “sliders” controlled by a mouse. The controls adjust the slope, x-intercept, or exponential function of a look-up table that is applied to the image, in order to modify the tone scale of the image when it is displayed or printed. However, because they do not directly adjust the scene exposure, they do not properly compensate for camera exposure or tone scale errors. While it is possible to somewhat improve the image using such controls, this is extremely difficult for unskilled users to determine how to best set these multiple controls.

### SUMMARY OF THE INVENTION

It is an object of the present invention to provide proper compensation for camera exposure and tone scale errors which is extremely simple for a non-expert user to understand and utilize.

It is a further object of the present invention to facilitate the printing of over and under exposed digital images captured by a capture device over a wide exposure range and which are to be printed by a printer to provide images with improved exposure and tone scale corrections which results in improved prints with improved exposure correction and improved tone scale.

It is another object of the present invention to facilitate the use of digital image processing by users, reducing their time to produce high quality images.

These objects are achieved by a method for correcting for exposure in a digital image which was captured by an image capture device and which is to be printed on a printer which forms monochrome or color images, on a medium, comprising the steps of:

a) providing a plurality of exposure and tone scale correcting transforms, each such transform being unique to an exposure condition and which corrects exposure and tone scale for a digital image captured by the capture device for such unique exposure conditions and to be printed by the printer;

b) applying the plurality of transforms to the digital image and printing a plurality of images corresponding to the digital image on which the transforms were applied; and

c) determining from the printed plurality of images the most satisfying printed image to the user, which corresponds a particular transform to be used to make visual images from the digital image.

### ADVANTAGES

Advantages of this method of correcting for camera exposure errors include:

1. A user with no experience will be able to produce the best possible printed image for exposure and tone scale in one step, the first time on a variety of printers.

2. The user can compare the printed series of digital images to the computer displayed series of digital images and arrive at a visual offset which educates the user to choose the proper image transform to correct future digital images, without having to make a composite print for every digital image file.

3. When this series of exposure error corrections is made, a tone scale correction may also be included that improves the look of the final print.

4. The present invention preserves the original file so that other corrections such as resizing and sharpening are possible.

It is another advantage of the present invention to provide an improved print that takes into consideration the operating characteristics of the capture device and the printer and corrects for exposure and tone scale by using a plurality of predetermined transforms which a user can readily choose to transform a digital image from a predetermined capture device and apply such transformed image to a printer to provide an aesthetically pleasing print.

### BRIEF DESCRIPTION OF THE DRAWINGS

FIG. 1 is a flow chart of the process for user to obtain a printed digital image corrected for exposure and tone scale;

FIG. 2 is a block diagram for creating the over and under exposure correction transforms;

FIGS. 3A-I are examples of a plurality of representative printer transforms produced by FIG. 2 to correct for exposure and tone scale errors over a five-stop exposure range in accordance with the present invention; and

FIG. 4 depicts a representation of a display of visual images with each visual image having been transformed by the transforms of FIGS. 3A-I.

### DETAILED DESCRIPTION OF THE INVENTION

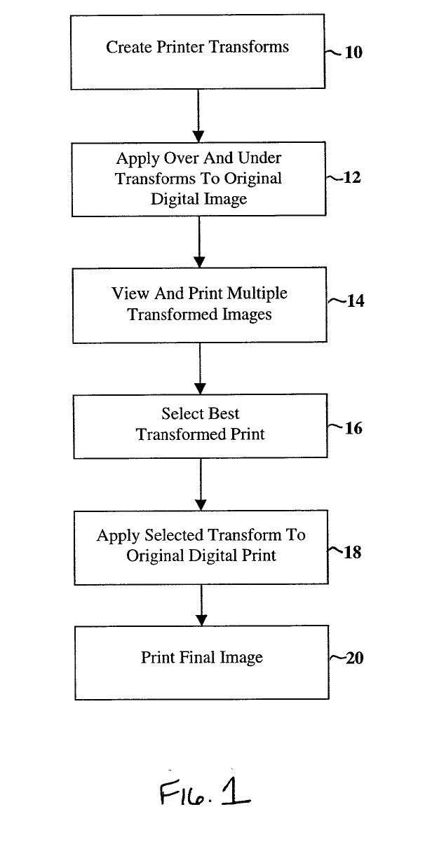

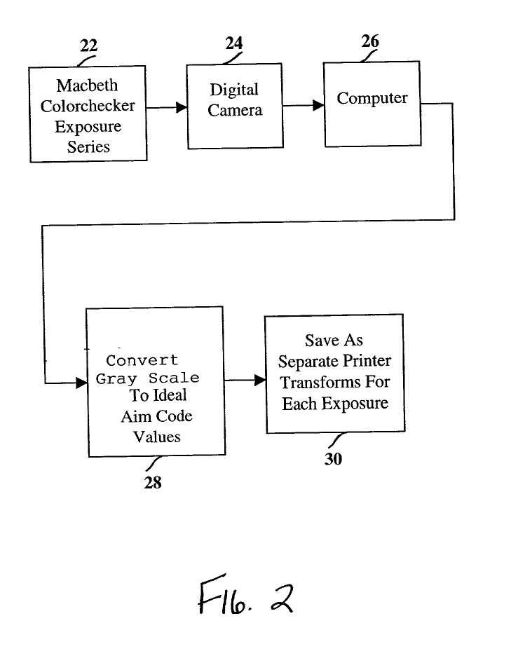

FIG. 1 describes the all over process of the invention. The first step 10 in the process involves the creation of the exposure and tone scale transforms (see steps 22-30 in FIG. 2). In step or block 12, the non-linear over and under correction transforms are applied to the original image 12. The resulting nine transformed images are viewed and printed 14. The exposure and tone scale correcting transforms are non-linear and each such transform is unique to an exposure condition which corrects exposure and digital image captured by the capture device for such unique exposure conditions and to be printed by the printer. The user selects the printed image that is judged most desirable (see block 16). In block 18, the transform that produced the most desirable miniature print is applied to the original image. In block 20, a final most desirable print is produced.

FIG. 2 outlines the preferred procedure to create the exposure and tone scale transforms. A Macbeth Color Checker Exposure Series 22 is captured by a digital camera 24 over an exposure range of two stops overexposure to two stops underexposure. Preferably, the image capture device is a digital camera and the medium can be a photographic silver halide element, ink jet receiver or thermal print medium. The resulting digital image files are delivered to a computer 26. The average input color code values of each neutral patch of the test chart are measured using an image processing program such as Adobe Photoshop 5.0. Using Adobe Photoshop 5.0 the input code values of the gray scale of the Macbeth Color Checker Exposure Series 22 are converted to output code values (transforms) that produce ideal aim values for a specific printer and correspond to printed reflection densities of 0.08, 0.18, 0.30, 0.65, 1.50, and 1.75. The input-output transforms for each exposure condition are saved in block 30 to correct a digital image for exposure and tone scale errors.

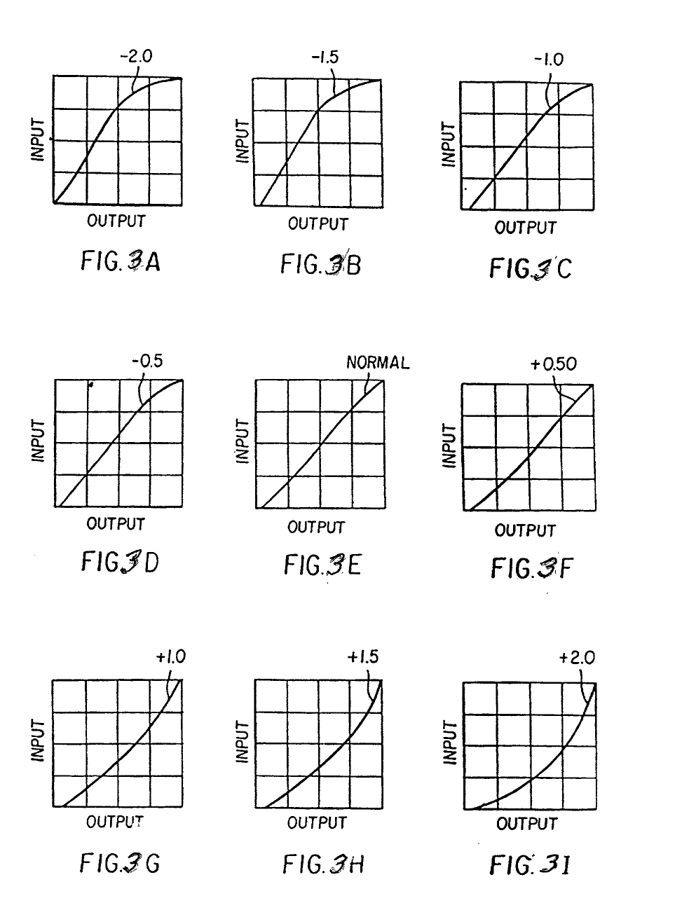

FIG. 3 shows representative transforms 3A-31 to correct over and underexposure digital images over the range from two stops over to two stops under at ½ stop increments.

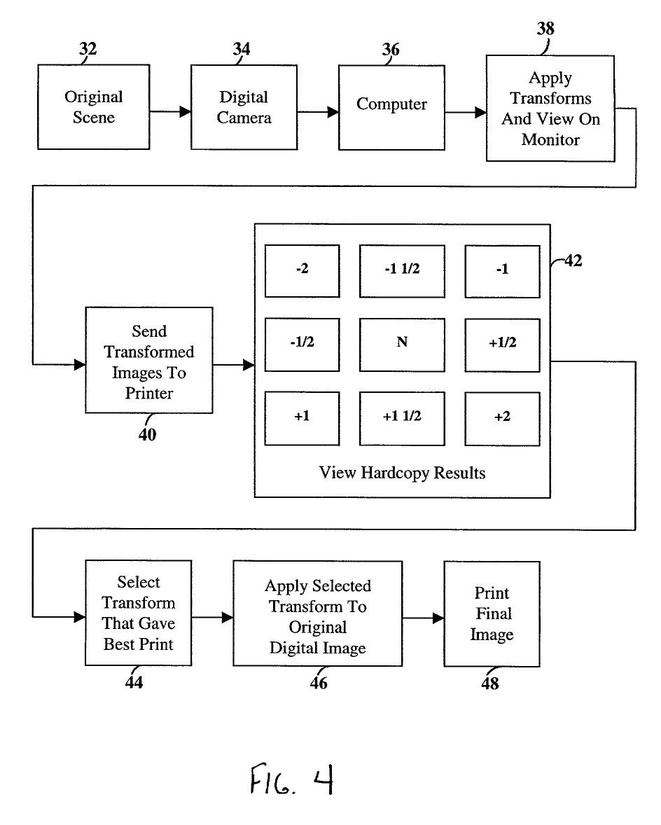

FIG. 4 outlines the steps in detail once the transforms have been converted to a Photoshop Action item as outlined in Example 1. The original scene 32 is photographed with a digital camera 34. The digital image file is delivered into a computer 36 using Adobe Photoshop 5.0. The action item created in Example 1 is applied to the original image file. This action item applies, as shown in block 38, nine separate transforms to the original digital image with the result that nine miniature images appear on the computer screen. Each miniature image has applied to it a separate transform that corrects for exposure error and tone scale over a five stop exposure range. The composite image with nine separately transformed images is sent to the printer which prints nine images (see block 45). The result is a composite print with nine separate miniature prints 42. In block 44, the user selects the print that is most satisfying and chooses the image transform that gave this best print and applies the transform to the original digital image and sends this new transformed digital image to the printer to obtain the best final image.

Print media, such as, but not limited to, thermal print and ink jet receivers, can produce images with a fairly wide dynamic range. The present invention makes it possible to produce transforms, which will produce tone scale curves that are capable of providing an even higher level of image quality than previously obtainable. As will be seen, it is very simple to implement these techniques to optimize tone scale curve adjustments. Although it is preferable to use nonlinear transforms, those skilled in the art will appreciate that mathematical transforms can also be used in accordance with the present invention that are unique to an exposure condition and which corrects exposure and tone scale for a digital image captured by the capture device for such unique exposure conditions and to be printed by the printer.

Image capture devices, in accordance with the present invention, can include digital cameras and scanners. Images that are captured, for example, on other origination sources (photographic paper, slides and negatives) can be converted to digital images by scanners. Printers, in accordance with the present invention, can be silver halide printers, thermal printers, ink jet printers, electrophotographic printers, and the like.

The present invention is applicable for printers, which produce monochrome or colored prints on a medium. However, it is also applicable for displaying images on a display such as a cathode ray tube (CRT) monitor. Moreover, the present invention is also applicable for making monochrome or colored prints. By the term “monochrome” is meant black and white or a single color and white.

FIGS. 3A-I are examples of a plurality of representative printer transforms for a specific combination of a specific digital camera, and printer and media combination produced by FIG. 2 to correct for exposure and tone scale errors over a five-stop exposure range in accordance with the present invention. More specifically, a Kodak DC260 camera was used with a power Macintosh 6500/300 computer, used with an Epson Stylus Photo 700 ink jet printer using Canon HG201 glossy film. Progressively, in each FIGS. 3A-3I, the illustrated transforms correct for exposure and tone scale errors over a five-stop exposure range from −2.0 to +2.0 stops in 0.5 stop increments. More specifically, FIG. 3A corresponds to a −2.0 stop under exposure and tone scale correction, whereas FIG. 3E is for a normal exposure, and FIG. 31 corresponds to a +2.0 stop over exposure and tone scale correction.

FIG. 4 schematically shows representations of nine separate images that were produced on a display by using the present invention. More particularly, these images are representative, but show the various exposure and tone scale corrections made by each transform.

### EXAMPLE 1

### Procedure for Creating Images that Correct for Tone Scale and for Over and Under Exposure Errors

In this example, the Photoshop software by Adobe was used.

Place a floppy disk that contains the nine transforms of FIG. 3 in the floppy disc drive of the computer.

Load a landscape oriented image into the computer to be used by Photoshop.

From Windows—Actions menu select ‘Create new set’ at the bottom of the Actions menu.

‘Name’ type in Composite

Select ‘OK’

From the Actions menu select ‘Create new action’ at the bottom of the actions menu window.

‘Name’ type in Over Under Composite

‘Set’ type in Composite

‘Function Key’ type in F4 or any F key

‘Color’ select in None

Click on ‘Record’

Select your landscape image then go to the ‘Image’ menu, select ‘Duplicate’, select ‘OK’.

A copy is placed as the top window.

Move this copy's title bar just below the title bar of the original.

Go to the ‘Image’ menu, ‘Image Size’

For ‘Print Size:’, the following was typed:

‘Width’ 3 ‘inches’

‘Height’ 2 ‘inches’

‘Resolution’ 300 ‘pixels/inch’

‘Constrain Proportions‘ place a check in the box.

‘Resample image’ select ‘Bicubic’ place a check in the box.

Nine separate images (copies 1-9) will now be created so that they can be viewed on a single screen. Copy 1 is already on the screen.

Duplicate the resized image with ‘Image’, ‘Duplicate’, select “OK”. Copy ‘2’ is placed as the top window. Move copy two's title bar just below the first copies title bar.

Duplicate the resized image with ‘Image’, ‘Duplicate’, select “OK”. Copy ‘3’ is placed as the top window. Move copy three's title bar just below the first copies title bar.

Duplicate the resized image with ‘Image’, ‘Duplicate’, select “OK”. Copy ‘4’ is placed as the top window. Move copy four's title bar just below the first copies title bar.

Duplicate the resized image with ‘Image’, ‘Duplicate’, select “OK”. Copy ‘5’ is placed as the top window. Move copy five's title bar just below the first copies title bar.

Duplicate the resized image with ‘Image’, ‘Duplicate’, select “OK”. Copy ‘6’ is placed as the top window. Move copy six's title bar just below the first copies title bar.

Duplicate the resized image with ‘Image’, ‘Duplicate’, select “OK”. Copy ‘7’ is placed as the top window. Move copy seven's title bar just below the first copies title bar.

Duplicate the resized image with ‘Image’, ‘Duplicate’, select “OK”. Copy ‘8’ is placed as the top window. Move copy eight's two's title bar just below the first copies title bar.

Duplicate the resized image with ‘Image’, ‘Duplicate’, select “OK”. Copy ‘9’ is placed as the top window. Move copy nine's title bar just below the first copies title bar

Nine (9)-2 inch by 3 inch images or copies were produced and displayed.

The digital images corresponding to the nine displayed images will now individually be transformed each using a different transform shown in FIGS. 3A-3I.

At this point, a single print is to be made having nine separately transformed images.

Go to ‘File’, ‘New’ to create the image file that will contain the nine miniature duplicate 3″×2″ landscape images.

‘Name’ Over Under Composite

‘Width’ 10 ‘inches’

‘Height’ 8 ‘inches’

‘Resolution’ 300 ‘pixels per inch’

‘Mode’ RGB Color

‘Contents’ White

At this point, nine separate original images are to be created, each using a different transform as shown in FIGS. 3A-3I. The term “original” is used since each image will be different from the original duplicate images. Select the last duplicate digital image copy 9 of the 3×2 resized duplicate image.

Go to the ‘Image’, ‘Adjust’, ‘Curves’

Select ‘Load’ from 3 1/2 Floppy (A:) and highlight the file

DC260_SRGB_minus_{—}60.acv (−2.0 curve FIG. 3A), select ‘load’, “OK”.

Go to ‘Select’, ‘All’

Go to ‘Edit’, ‘Copy’

Select the title bar your over under composite image.

Go to ‘Edit’, ‘Paste’

Now a new original image is shown on the display.

Select move tool from the tool bar and move the image to the top row in the upper left corner.

Select copy 9(the image you just pasted) and delete the image with ‘File’,‘Close’, select ‘no don't save’.

Select copy 8 of the 3×2 resized duplicate image.

Go to the ‘Image’, ‘Adjust’, ‘Curves’

Select ‘Load’ from 3½ Floppy (A:) and highlight the file

DC260_SRGB_minus—45.acv (−1.5 curve FIG. 3B), select ‘load’, “OK”.

Go to ‘Select’, ‘All’

Go to ‘Edit’,‘Copy’

Select the title bar your over under composite image.

Go to ‘Edit’, ‘Paste’

Select move tool from the tool bar and move the second original image to the top row middle position.

Select copy 8 (the image you just pasted) and delete the image with ‘File’,‘Close’, select ‘no don't save’.

Select copy 7 of the 3×2 resized duplicate image.

Go to the ‘Image’, ‘Adjust’, ‘Curves’

Select ‘Load’ from 3½ Floppy (A:) and highlight the file

DC260_SRGB_minus_{—}30.acv(−1.0 curve FIG. 3C), select ‘load’, “OK”.

Go to ‘Select’, ‘All’

Go to ‘Edit’, ‘Copy’

Select the title bar your over under composite image.

Go to ‘Edit’, ‘Paste’

Select move tool from the tool bar and move the third original image to the top row in the upper night comer.

Select copy 7(the image you just pasted) and delete the image with ‘File’,‘Close’, select ‘no don't save’.

Select copy 6 of the 3×2 resized duplicate image.

Go to the ‘Image’, ‘Adjust’, ‘Curves’

Select 1 Load’ from 3½ Floppy (A:) and highlight the file

DC260_SRGB_{—minus}_{—}15.acv (−0.5 curve FIG. 3D), select ‘load’, “OK”.

Go to ‘Select’, ‘All’

Go to ‘Edit’,‘Copy’.

Select the title bar your over under composite image.

Go to ‘Edit’, ‘Paste’

Select move tool from the tool bar and move the fourth original image to the middle row left side.

Select copy 6 (the image you just pasted) and delete the image with ‘File’, ‘Close’, select ‘no don't save’.

Select copy 5 of the 3×2 resized duplicate image.

Go to the ‘Image’, ‘Adjust’, ‘Curves’

Select ‘Load’ from 3 1/2 Floppy (A:) and highlight the file

DC260_SRGB_minus_normal.acv(normal curve FIG. 3E), select ‘load’, “OK”.

Go to ‘Select’, ‘All’

Go to ‘Edit’, ‘Copy’.

Select the title bar your over under composite image.

Go to ‘Edit’, ‘Paste’

Select move tool from the tool bar and move the fifth original image to the middle row center position.

Select copy 5(the image you just pasted) and delete the image with ‘File’, ‘Close’, select ‘no don't save’.

Select copy 4 of the 3×2 resized duplicate image.

Go to the ‘Image’, ‘Adjust’, ‘Curves’

Select ‘Load’ from 3½ Floppy (A:) and highlight the file

DC260_SRGB_plus_{—}15.acv(+0.50 curve FIG. 3F), select ‘load’, “OK”.

Go to ‘Select’, ‘All’

Go to ‘Edit’,‘Copy’.

Select the title bar your over under composite image.

Go to ‘Edit’, ‘Paste’

Select move tool from the tool bar and move the sixth original image to the middle row right side.

Select copy 4 (the image you just pasted and delete the image with ‘File’, ‘Close’, select ‘no don't save’.

Select copy 3 of the 3×2 resized duplicate image.

Go to the ‘Image’, ‘Adjust’, ‘Curves’

Select ‘Load’ from 3½ Floppy (A:) and highlight the file

DC260_SRGB_plus_{—}30.acv(+1.0 curve FIG. 3G), select ‘load’, “OK”.

Go to ‘Select’, ‘All’

Go to ‘Edit’, ‘Copy’

Select the title bar your over under composite image.

Go to ‘Edit’, ‘Paste’

Select move tool from the tool bar and move the seventh original image to the bottom row in the lower left comer.

Select copy 3 (the image you just pasted) and delete the image with ‘File’, ‘close’, select ‘no don't save’.

Select copy 2 of the 3×2 resized duplicate image.

Go to the ‘Image’, ‘Adjust’, ‘Curves’

Select ‘Load’ from 3½ Floppy (A:) and highlight the file

DC260_SRGB_plus_{—}45.acv(+1.5 curve FIG. 3H), select ‘load’, “OK”.

Go to ‘Select’, ‘All’

Go to ‘Edit’, ‘Copy’

Select the title bar your over under composite image.

Go to ‘Edit’, ‘Paste’

Select move tool from the tool bar and move the eighth original image to the bottom row in the middle position.

Select copy 2 (the image you just pasted) and delete the image with ‘File’, ‘Close’, select ‘no don't save’.

Select copy 1 of the 3×2 resized duplicate image.

Go to the ‘Image’, ‘Adjust’, ‘Curves’

Select ‘Load’ from 3½ Floppy (A:) and highlight the file

DC260_SRGB_plus_{—}60.acv(+2.0 curve FIG. 3I), select ‘load’, “OK”.

Go to ‘Select’, ‘All’Go to ‘Edit’, ‘Copy’

Select the title bar your over under composite image.

Go to ‘Edit’, ‘Paste’

At this point, there were nine duplicate images and nine transformed original images (18 images) on the screen. The nine duplicate images were deleted as follows:

Select move tool from the tool bar and move the ninth original image to the bottom row in the lower right comer.

Select copy 1 (the image you just pasted) and delete the image with ‘File’, ‘Close’, select ‘no don't save’.

The image now contains nine miniature duplicates of the original image with nine transfer functions applied.

Label the miniature images as follows:

Select the text tool.

Click the mouse underneath in the top row and left hand comer. In the text tool window type in −2 using black type and a height of 12 points.

Click the mouse underneath the image in the top row and middle position. In the text tool window type in −1½ using black type and a height of 12 points.

Click the mouse underneath the image in the top row and right hand corner. In the text tool window type in −1 using black type and a height of 12 points.

Click the mouse underneath the image in the middle row and left hand corner. In the text tool window type in −½ using black type and a height of 12 points.

Click the mouse underneath the image in the middle row and center position. In the text tool window type in −N using black type and a height of 12 points.

Click the mouse underneath the image in the middle row and right hand corner. In the text tool window type in +½ using black type and a height of 12 points.

Click the mouse underneath the image in the bottom row and left hand corner. In the text tool window type in +1 using black type and a height of 12 points.

Click the mouse underneath the image in the bottom row and center position. In the text tool window type in +1½ using black type and a height of 12 points.

Click the mouse underneath the image in the bottom row and right hand corner. In the text tool window type in +2 using black type and a height of 12 points.

Go to the ‘Layer’ menu and select ‘Flatten Image’.

Select ‘Stop actions’ at the bottom of the actions window or through the look in arrow.

Now, for the landscape image in Adobe Photoshop 5.0, the F4 key was selected (or the key specified) and automatically created an 8×10 image with nine miniature original images. Each miniature original image had a transfer function applied for digital exposure compensation of −2 to +2 in ½ stop increments. In operation, a new digital file with the nine separate transforms applied was sent to a printer designed to print SRGB type images where nine original images were printed.

The user now observes the printed set of original images and visually determines which one of those images is more satisfactory to the user. The selected original image can be within ½ stop of the best exposure corrected and tone scale print that was produced by the particular camera and printer utilized. An identical procedure can be created for vertical images.

Transforms made in accordance with the present invention can be stored in a computer readable storage medium. The computer readable storage medium may comprise, for example; magnetic storage media such as magnetic disc (such as a floppy disc) or magnetic tape; optical storage media such as optical disc, optical tape drive, or machine readable bar code; solid state electronic storage devices such as flash memory card, or read only memory (ROM); or any other physical device or medium employed to store a computer program.

The invention has been described in detail with reference to certain preferred embodiments thereof, but it will be understood that variations and modifications can be effected within the spirit and scope of the invention.

This procedure has been implemented with a series of digital cameras which include Kodak digital cameras DCS 460, DCS620, DC260, and DC4800.

This procedure has also been implemented with Epson 875DC and Epson 2000P ink jet printers as well as the Kodak 8600 Thermal Printer.

This procedure has also been implemented with scanned film images converted to SRGB which originated from Kodak Photo CD images, Kodak Picture CD images, or scanned images from a Nikon LS2000 scanner.

PARTS LIST

| | |
|---|---|
| 10 | create printer transforms |
| 12 | apply transforms |
| 14 | view transformed images |
| 16 | select best print |
| 18 | apply transform to original image |
| 20 | print final image |
| 22 | Macbeth Color Checker |
| 24 | digital camera |
| 26 | computer |
| 28 | transform input code values to ouput aim code values |
| 30 | save transforms for each exposure |
| 32 | original scene |
| 34 | digital camera |
| 36 | computer |
| 38 | block |
| 40 | block |
| 42 | block |
| 44 | block |
| 46 | block |
| 48 | block |

What is claimed is:

1. A method for correcting for exposure in a digital image which was captured by an image capture device and which is to be printed on a printer which forms monochrome or color images, on a medium, comprising the steps of:
a) providing a plurality of exposure and tone scale correcting transforms, each such transform being unique to an exposure condition and which corrects exposure and tone scale for a digital image captured by the capture device for such unique exposure conditions and to be printed by the printer;
b) applying the plurality of transforms to the digital image and printing a plurality of images corresponding to the digital image on which the transforms were applied; and
c) determining from the printed plurality of images the most satisfying printed image to the user which corresponds a particular transform to be used to make visual images from the digital image.

2. A method for correcting for exposure in a digital image which was captured by an image capture device and which is to be printed on a printer which forms monochrome or color images, on a medium, comprising the steps of:
a) providing a plurality of exposure and tone scale correcting transforms, each such transform being unique to an exposure condition and which corrects exposure and tone scale for a digital image captured by the capture device for such unique exposure conditions and to be printed by the printer;
b) applying the plurality of transforms to the digital image and producing a plurality of visual digital images on a display and printing on a particular printer such plurality of visual digital images corresponding to the digital image on which the transforms were applied; and
c) determining from the printed plurality of images the most satisfying printed image to the user which corresponds a particular transform to be used to make visual images from the digital image so that the user can correlate the difference between display and printed images.

3. The method of claim 2 wherein the particular transform is used to make one or more printed images using the particular transform of the selected digital images.

4. A method for correcting for exposure in a digital image which was captured by an image capture device and which is to be printed on a printer which forms monochrome or color images, on a medium, comprising the steps of:
a) providing a plurality of exposure and tone scale correcting nonlinear transforms, each such nonlinear transform being unique to an exposure condition and which corrects exposure and tone scale for a digital image captured by the capture device for such unique exposure conditions and to be printed by the printer;
b) applying the plurality of nonlinear transforms to the digital image and producing a plurality of visual digital images on a display and printing on a particular printer such plurality of visual digital images corresponding to the digital image on which the nonlinear transforms were applied; and
c) determining the most satisfying printed image to the user which corresponds a particular nonlinear transform to be used to make visual images from the digital image which is corrected for exposure and tone scale when printed by the printer.

5. The method of claim 4 wherein the image capture device is a digital camera and the medium is a photographic silver halide element, ink jet receiver or thermal print medium.
